(19) United States
(12) Patent Application Publication
(10) Pub. No.: US 2011/0063574 A1
(43) Pub. Date: Mar. 17, 2011

(54) Three-Dimensional Display Using an Invisible Wavelength Light Source

(75) Inventor: Mark O. Freeman, Snohomish, WA (US)

(73) Assignee: MICROVISION, INC., Redmond, WA (US)

(21) Appl. No.: 12/560,549

(22) Filed: Sep. 16, 2009

(51) Int. Cl. G02B 27/22; G03B 21/00

(52) U.S. Cl. 353/7; 353/121

(57) ABSTRACT

Briefly, in accordance with one or more embodiments, a full color image and an invisible wavelength monochrome image are projected onto a display screen via a scanning platform of a scanned beam display. The monochrome image is re-radiated from a Photoluminescent material of the display screen as a visible wavelength monochrome image. The overall image may be viewed by a viewer as a three-dimensional image by providing the monochrome image to a first eye of the user without the full color image, and providing the full color image to a second eye of the user without the monochrome image.

### BACKGROUND

One of the most common approaches to displaying three-dimensional (3D) video is based on stereo vision. In stereo vision 3D, two different images each from a slightly different perspective are presented, one to each of the viewer's eye. Such a 3D system involves projecting two different images and presenting each eye with only one of the images. One approach to providing each eye with one of the images is four-color 3D in which one eye is presented with a full color image comprising three colors and the other eye is presented with a monochrome image comprising a fourth color. The monochrome color typically is selected to have a wavelength in the region of higher eye sensitivity, referred to as the photopic response, for example yellow. However, for a lower power laser based system having generally smaller form factors, utilizing a yellow laser to implement a four-color 3D system may not be practical.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a scanned beam display capable of displaying a three-dimensional image in accordance with one or more embodiments;

FIG. 2 is a block diagram of the electronic circuits of a scanned beam display capable of displaying a three-dimensional image in accordance with one or more embodiments;

FIG. 3 is a diagram of a three-dimensional scanned beam display system including a display screen and glasses in accordance with one or more embodiments;

FIG. 4 is a diagram illustrating the generation of a monochrome image and a full color image in accordance with one or more embodiments;

FIG. 5 is a flow diagram of a method to generate a three-dimensional image in accordance with one or more embodiments; and

FIG. 6 is a block diagram of an information handling system utilizing a three-dimensional display projector in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

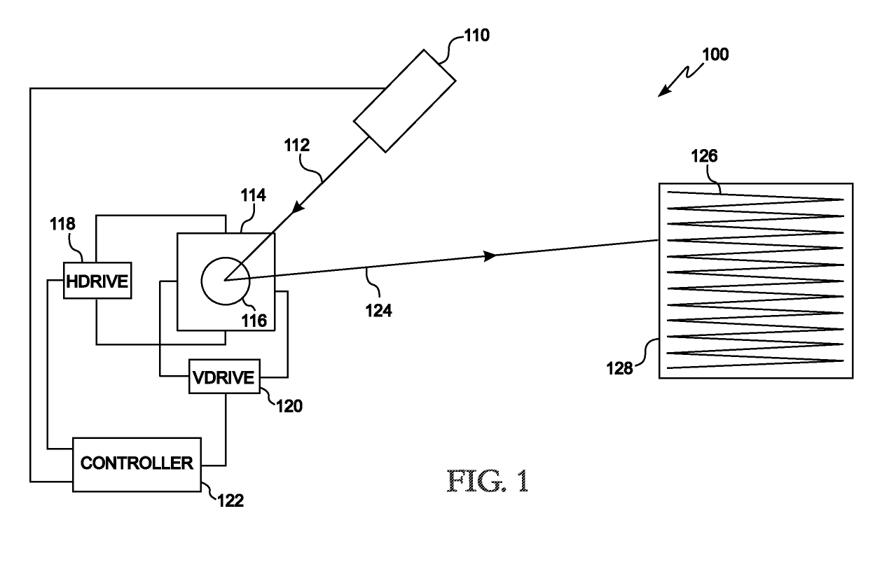

Referring now to FIG. 1, a diagram of a scanned beam display in accordance with one or more embodiments will be discussed. Although FIG. 1 illustrates one type of a scanned beam display system for purposes of discussion, for example a microelectromechanical system (MEMS) based display, it should be noted that other types of scanning displays including those that use two uniaxial scanners, rotating polygon scanners, or galvonometric scanners as well as systems that use the combination of a one-dimensional spatial light modulator with a single axis scanner as some of many examples, may also utilize the claimed subject matter and the scope of the claimed subject matter is not limited in this respect. Furthermore, projectors that are not scanned beam projectors but rather have two-dimensional modulators that introduce the image information in either the image plane or Fourier plane and which introduce color information time sequentially or using a filter mask on the modulator as some of many examples, may also utilize the claimed subject matter and the scope of the claimed subject matter is not limited in this respect. Scanned beam display 100 may be adapted to project a three-dimensional image as discussed herein. Details of operation of scanned beam display are discussed, below.

As shown in FIG. 1, scanned beam display 100 comprises a light source 110, which may be a laser light source such as a laser or the like, capable of emitting a beam 112 which may comprise a laser beam. In some embodiments, light source may comprise two or more light sources, such as in a color system having red, green, and blue light sources, wherein the beams from the light sources may be combined into a single beam. In one or more embodiments, light source may include a first full color light source such as a red, green, and blue light source, and in addition may include a fourth light source to emit an invisible beam such as an ultraviolet beam or an infrared beam. The beam 112 is incident on a scanning platform 114 which may comprise a microelectromechanical system (MEMS) based scanner or the like in one or more embodiments, and reflects off of scanning mirror 116 to generate a controlled output beam 124. In one or more alternative embodiments, scanning platform 114 may comprise a diffractive optic grating, a moving optic grating, a light valve, a rotating mirror, a spinning silicon device, a digital light projector device, a flying spot projector, or a liquid-crystal on silicon device, or other similar scanning or modulating devices. A horizontal drive circuit 118 and/or a vertical drive circuit 120 modulate the direction in which scanning mirror 116 is deflected to cause output beam 124 to generate a raster scan 126, thereby creating a displayed image, for example on a display screen and/or image plane 128. A display controller 122 controls horizontal drive circuit 118 and vertical drive circuit 120 by converting pixel information of the displayed image into laser modulation synchronous to the scanning platform 114 to write the image information as a displayed image based upon the position of the output beam 124 in raster pattern 126 and the corresponding intensity and/or color information at the corresponding pixel in the image. Display controller 122 may also control other various functions of scanned beam display 100.

In one or more embodiments, for two dimensional scanning to generate a two dimensional image ultimately with a three-dimensional effect, a horizontal axis may refer to the horizontal direction of raster scan 126 and the vertical axis may refer to the vertical direction of raster scan 126. Scanning mirror 116 may sweep the output beam 124 horizontally at a relatively higher frequency and also vertically at a relatively lower frequency. The result is a scanned trajectory of laser beam 124 to result in raster scan 126. The fast and slow axes may also be interchanged such that the fast scan is in the vertical direction and the slow scan is in the horizontal direction. However, the scope of the claimed subject matter is not limited in these respects.

In one or more particular embodiments, the scanned beam display 100 as shown in and described with respect to FIG. 1 may comprise a pico-projector developed by Microvision Inc., of Redmond, Wash., USA, referred to as PicoP™. In such embodiments, light source 110 of such a pico-projector may comprise one red, one green, one blue, and one invisible wavelength laser, with a lens near the output of the respective lasers that collects the light from the laser and provides a very low numerical aperture (NA) beam at the output. The light from the lasers may then be combined with dichroic elements into a single white beam 112. Using a beam splitter and/or basic fold-mirror optics, the combined beam 112 may be relayed onto biaxial MEMS scanning mirror 116 disposed on scanning platform 114 that scans the output beam 124 in a raster pattern 126. Modulating the lasers synchronously with the position of the scanned output beam 124 may create the projected image. In one or more embodiments the scanned beam display 100, or engine, may be disposed in a single module known as an Integrated Photonics Module (IPM), which in some embodiments may be 7 millimeters (mm) in height and less than 5 cubic centimeters (cc) in total volume, although the scope of the claimed subject matter is not limited in these respects.

In one or more embodiments, the technology utilized for the red and blue lasers in scanned beam display 100 may be substantially similar to the technology of similar lasers that are used for the optical disk storage devices, with the main difference being a slight shift in the particular wavelengths provided by the lasers. Such lasers may be fabricated from materials such as gallium aluminum indium phosphide (GaAlInP) for red laser diodes and gallium nitride (GaN) for blue laser diodes. In one or more embodiments, the technology for green lasers may be based on infrared or near-infrared lasers developed for the telecom industry. Near-infra-red laser diodes with very high modulation bandwidths may be utilized in combination with a frequency-doubling crystal, for example periodically poled lithium niobate (LiNbO3), to produce a green laser that is capable of being directly modulated. The choice of which wavelength to use for the lasers is based at least in part on at least two considerations. First is the response of the human eye, known as the photopic response, to different wavelengths. This response is an approximate Gaussian curve that peaks at or near the green-wavelength region and falls off significantly in red and blue regions. The amount of red and blue power needed to get a white-balanced display may vary rapidly with wavelength. For example, eye response increases by a factor of two when the wavelength is changed from 650 nanometers (nm), the wave-length used for digital video disc (DVD) drives, to 635 nm. Such a change in wavelength allows the required laser power to drop by the same factor, thereby resulting in scanned beam display 100 that is able to operate at lower power. Similarly, the blue laser may be chosen to have as long a wavelength as possible. Currently, blue lasers in the range of 440 to 445 nm are typical, and eventually practical blue lasers having longer wavelengths in the range of 460 to 470 nm may be provided. The second consideration is color gamut. Since the photopic response is at or near peak value through the green wavelength range, the green wavelength may be chosen to enhance the color of the display. For example, green lasers at or near 530 nm may be utilized for maximizing or nearly maximizing the color gamut. Since the ability to directly modulate the lasers is a main feature of scanned beam display 100, pixel times at or near the center of a Wide Video Graphics Array (WVGA) scanned display may be on the order of 20 nanoseconds (ns). As a result, the lasers may have modulation bandwidths on the order of about 100 MHz. It should be noted that these are merely examples for the types and characteristics of the lasers that may be utilized in scanned beam display 100, and the scope of the claimed subject matter is not limited in these respects. In one or more embodiments, the fourth, invisible laser may comprise an ultraviolet (UV) laser having a wavelength of about 380 or 390 nm or so and may range as low as about 200 nm up to about 400 nm or so, and/or generally about 400 nm or less. Such a UV laser may comprise, for example, Gallium Aluminum Nitride (GaAlN) or Gallium Indium Nitride (GaInN), among many examples. In alternate embodiments, the fourth, invisible laser may comprise an infrared (IR) laser having a wavelength of about 850 nm or so and in general may have a wavelength of about 750 nm or greater such as about 750 nm to about 1550 nm or so. Such an IR laser may comprise, for example, aluminum gallium arsenide (AlGaAs), indium gallium arsenide phosphate (InGaAsP), a vertical cavity surface emitting laser (VCSEL), a quantum cascade laser, a hybrid silicon laser, and so on. The choice of the invisible laser is based on multiple considerations which include the efficiency of the laser wavelength for exciting the photoluminescent material in the screen, commercial availability of the laser, and/or laser safety.

In one or more embodiments of scanned beam display 100, the remainder of the optics engine operates to generate a single pixel at a particular position of the output beam 124 in raster scan 126. All three lasers may be driven simultaneously at levels to create a proper color mix for each pixel to produce brilliant images with the wide color gamut available from red, green, blue (RGB) lasers in addition to the invisible wavelength laser. Direct-driving of the lasers pixel-by-pixel at or near the levels involved for each pixel provides suitable power efficiency and inherently high contrast. As a result, in such embodiments the efficiency of scanned beam display may be maximized or nearly maximized since the lasers may be only on at the level needed for each pixel. The contrast may be high because the lasers are completely off for black pixels rather than using, for example, a spatial light modulator (SLM) to deflect or absorb any excess intensity. The single-pixel collection optics may be optimized to take the particular beam properties of the red, green, and/or blue laser and relay it through the scanned beam display and onto the display screen 128 with high efficiency and/or image quality. The pixel profile may be designed to provide high resolution and infinite focus with a smooth non-pixelated image. In some embodiments, with a relatively simple optomechanical design for scanned beam display 100, at least some of the display complexity may be handled by the electronics systems to control accurate placement of pixels and to modulate the laser at pixel rates.

In one or more embodiments of a raster-scanned beam display 100, no projection lens may be utilized or otherwise needed. In such embodiments, the projected output beam 124 directly leaves the scanned beam display 100 and creates an image on whatever display screen 128 upon which output beam 124 is projected. Because of the scanned single pixel design, light-collection efficiency may be kept high by placing the collection lenses near the output of the lasers while the NA of output beam 124 is very low. By design, the rate of expansion of the single-pixel beam may be matched to the rate that the scanned image size grows. As a result, the projected image is always in focus. This special property of scanned beam display 100 comes from dividing the task of projecting an image into using a low NA single-pixel beam to establish the focus and a two-dimensional (2D) scanner to paint the image. In particular embodiments, the scanning platform 114 may implement the role of fast projection optics by producing an image that expands with a 43° horizontal projection angle. Such an arrangement may not be achieved in more traditional projector designs where projection optics may be used to image a spatial light modulator onto the projection screen due to conflicting constraints on the projection lens. On the one hand, a short focal length lens may be utilized to create an image that grows quickly with projection distance, while on the other hand, the lens aperture is typically large to maximize the projector's brightness. Such constraints may involve a fast projection lens with F/2 lenses being typical. Depth of focus is proportional to F-stop. The trade-off for traditional projector designs balances the rate the image grows with distance, light efficiency and/or depth of focus.

In some embodiments of scanned beam display 100, the spot size as a function of projection distance may grow at a rate matched or close to the growth of a single pixel. Assuming a moderately fast F/4 projection lens and a focal length chosen to give the same 43° rate or growth with projection distance for the projected image, the depth of locus for an imaging-type projector is greatly reduced compared to the scanned laser. To the user, this means that the typical imaging-type projector should be refocused as the projection distance is changed, and that portions of the image may be out of focus when one projects onto surfaces that present a range of projection distances within the image, for example projecting onto a flat surface at an angle or onto surfaces with a significant three-dimensional (3D) profile.

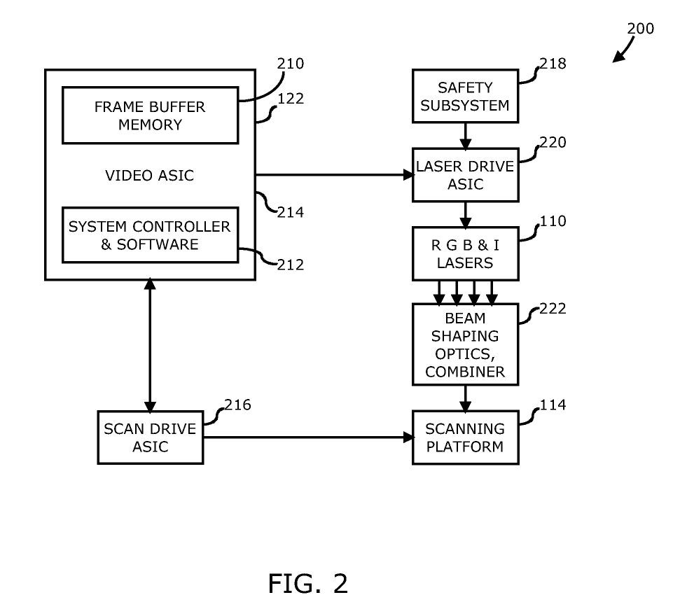

Referring now to FIG. 2, a block diagram of the electronic circuits of a scanned beam display in accordance with one or more embodiments will be discussed. With the simplification of the optomechanical projector engine design, a greater portion of the display emphasis may be shifted to the electronics. This allows the physical size of the projector engine to be relatively minimized to accommodate hand-held consumer products. The electronics, which can be integrated more straight-forwardly into consumer products, take over tasks that are done optically with other projector designs. Some of the tasks that are shifted include pixel positioning, color alignment and brightness uniformity. In some embodiments of scanned beam display 100, the video processor and controller 122 for scanning platform 114 may be implemented as one or more custom application-specific integrated circuits (ASICs) that drive the scanned beam display 100 of FIG. 1.

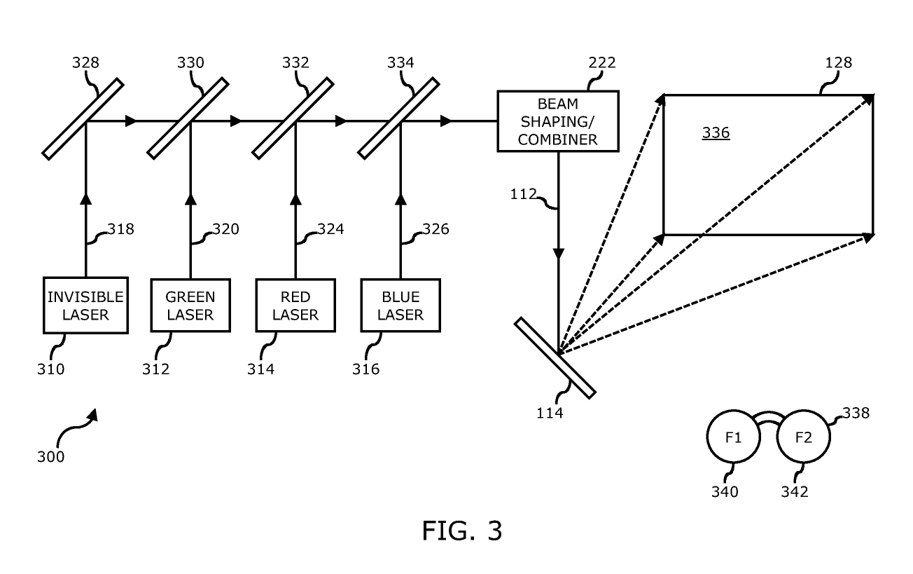

In one or more embodiments, such an electronics system 200 may comprise scan drive ASIC 216 which may comprise horizontal drive circuit 118 and vertical drive circuit 120 as shown in FIG. 1 for driving scanning platform 114 to generate a raster scan 126. In some embodiments, scan drive ASIC 218 may drive scanning platform 114 under closed loop control. The horizontal scan motion may be created by driving the horizontal axis of scanning platform 114 at its resonant frequency which typically may be about 18 kHz for a Wide Video Graphics Array (WVGA) type scanner. The horizontal scan velocity may vary sinusoidally with position. In particular embodiments, scan drive ASIC 216 may utilize feedback from sensors on scanning platform 114 to keep the system on resonance and/or at fixed scan amplitude. The projected image is drawn in both directions as scanning platform 114 sweeps the beam back and forth. Such an arrangement may increase the efficiency of scanning platform 114 in at least two ways. First, by running on resonance the power required to drive the scan mirror may be reduced and/or minimized. However, in some embodiments scanning platform 114 may be non-resonantly driven. Second, bi-directional video increases and/or maximizes the laser use efficiency by minimizing the video blanking interval. As a result, the image projected by scanned beam display 100 may be brighter for a given power output of the four lasers 110, although the scope of the claimed subject matter is not limited in these respects. In some embodiments, the vertical scan direction may be driven with a standard sawtooth waveform to provide constant velocity from the top to the bottom of the image and a rapid retrace back to the top to begin a new frame. The vertical scan motion also may be managed in closed loop fashion by scan drive ASIC 216 based at least in part on position feedback from scanning platform 114 to maintain a smooth and/or linear trajectory. The frame rate typically may be 60 Hz for an 848×480 WVGA resolution. The frame rate may be increased if the projector is used in lower resolution applications, although the scope of the claimed subject matter is not limited in this respect. Further details of the scan drive waveforms are shown in and described with respect to FIG. 3, below.

In one or more embodiments, controller 122 of FIG. 1 may comprise a video ASIC 214 as shown in FIG. 2 as an embodiment of controller 122. In some embodiments, video ASIC 214 accepts either red, green, blue (RGB) and/or luma/chrominance (YUV) video signal inputs, in addition to a monochrome signal for the invisible wavelength laser. Video ASIC 214 may include a frame buffer memory 210 to allow artifact free scan conversion of input video. Gamma correction and/or color space conversion may be applied to enable accurate mapping of input colors to the wide laser color gamut. An optional scaling engine may be provided for upconverting lower resolution video content. In one or more embodiments, video ASIC 214 may implement a Virtual Pixel Synthesis (VPS) engine that utilizes high-resolution interpolation to map the input pixels to the sinusoidal horizontal trajectory of scanning platform 114. Such a VPS engine is an example of how functions of scanned beam display 100 may be shifted from being implemented in optics to being implemented electronics by electronics system 200 in a scanned laser paradigm. The VPS engine effectively may map the input pixels onto a high-resolution virtual coordinate grid. Besides enabling the repositioning of video information with subpixel accuracy onto the sinusoidal scan, the VPS engine may further optimize the quality of the projected image. Brightness uniformity also may be managed in the VPS engine by adjusting coefficients that control the overall brightness map for the scanned beam display 100.

In one or more embodiments, the VPS engine implemented by video ASIC 214 may compensate optical distortions, for example keystone, parallelogram, and/or some types of pincushion distortion, and/or any arbitrary or intentional type of distortion including but not limited to distortion from varying surface profile or relief, wherein the VPS engine may be utilized to adjust the pixel positions. The VPS engine also may allow the pixel positions for each color to be adjusted independently. Such an arrangement may simplify the manufacturing alignment of scanned beam display 100 by relaxing the requirement that the three laser beams of laser 110 be perfectly mechanically aligned. The positions of the red, green, blue, and/or invisible light pixels may be adjusted electronically to bring the video into perfect, or nearly perfect, alignment, even if the laser beams are not themselves sufficiently aligned. Such an electronic pixel alignment capability also may be utilized to compensate for some types of chromatic aberration if scanned beam display 100 is deployed as an engine in a larger optical system, although the scope of the claimed subject matter is not limited in this respect. In some embodiments, mapping from digital video coding performed by video ASIC 214 to laser drive ASIC 220 may be performed by an Adaptive Laser Drive (ALD) system implemented by system controller and software 212. In some embodiments, the ALD may comprise a closed-loop system that utilizes optical feedback from each laser to actively compensate for changes in the laser characteristics over temperature and/or aging. Such an arrangement may ensure optimum, or nearly optimum, brightness, color and/or grayscale performance. Unlike other display systems, optical feedback further may be incorporated to ensure optimum color balance and/or grayscale. Other electronic blocks in electronics system 200 may include safety subsystem 218 to maintain the output power of lasers 100 within safe levels, and/or beam shaping optics and combiner 222 to shape and/or combine the beams from individual lasers 110 into a single beam applied to scanning platform 114. However, FIG. 2 shows one example arrangement of electronics system 200 of a scanned beam display, and the scope of the claimed subject matter is not limited in these respects.

In one or more embodiments, the components of scanned beam display 100 and/or components of electronics system 200 may be arranged for operation in a mobile format or environment. Such an example scanned beam display 100 may include the following specifications. The height or thickness and/or volume of scanned beam display 100 may be minimized or nearly minimized, for example a height from about 7 to 14 mm and in overall volume from 5 to 10 cubic centimeters (cc). Brightness may be affected by the available brightness of the light sources, either lasers or light emitting diodes (LEDs), the optical efficiency of the projector design, and/or lower-power operation in order to maximize battery life. In some embodiments, the brightness of the image projected by scanned beam display may be in the range of about 5 to 10 lumens. For image size, a projection angle in the range of 30 to 45 degrees may be utilized and in one or more particular embodiments the projection angle may be about 53 degrees with a one-to-one (1:1) distance to image size ratio, although the scope of the claimed subject matter is not limited in these respects. For mobile applications, scanned beam display 100 may provide focus free operation wherein the distance from the display to the displayed image will likely change often. The wide screen format generally may be desirable for viewing video content wherein scanned beam display 100 may provide resolutions from quarter video graphics array (QVGA) comprising 320×240 pixels to wide video graphics array (WVGA) comprising 848×480 pixels, as merely some examples. In some embodiments, scanned beam display 100 typically utilizes either color lasers and/or red, green, blue, and invisible wavelength LEDs for light sources. In both embodiments, the result is large color gamuts that far exceed the usual color range typically provided televisions, monitors, and/or conference-room-type projectors. In some embodiments, white LEDs may be utilized used with color filters to yield a reduced color gamut. Contrast likewise may be maximized, or nearly maximized. Contrast may be referred to as the dynamic range of scanned beam display 100. In one or more embodiments, a target specification for power consumption may be to provide a battery life sufficient to watch an entire movie, which may be at least about 1.5 hours. It should be noted that these are merely example design specifications for scanned beam display 100, and the scope of the claimed subject matter is not limited in these respects.

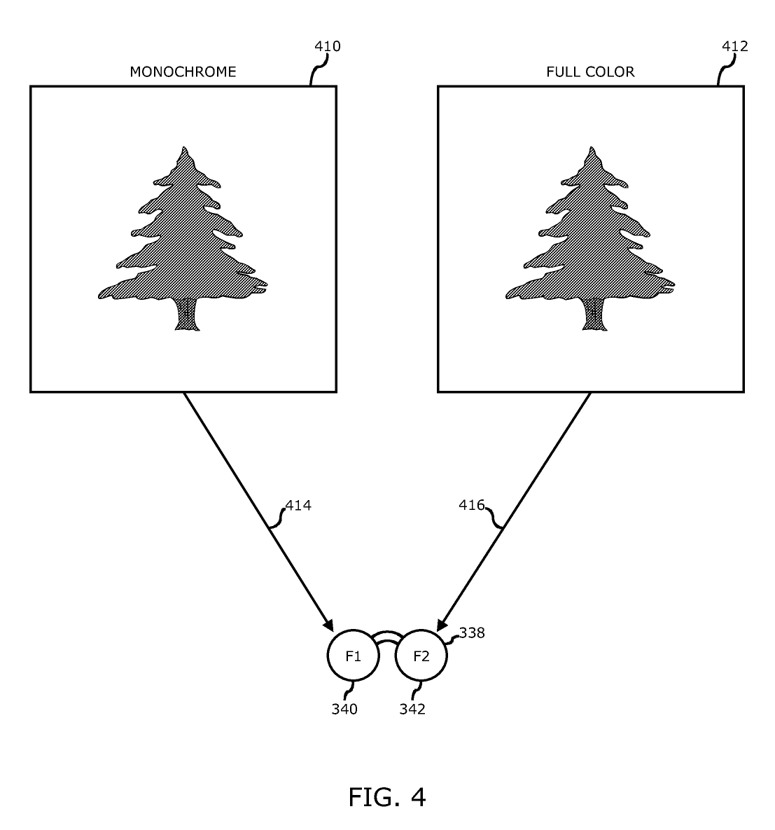

Referring now to FIG. 3, diagram of a three-dimensional scanned beam display system including a display screen and glasses in accordance with one or more embodiments will be discussed. FIG. 3 shows a complete or nearly complete system 300 for generating a three-dimensional image using lasers to generate the image as discussed herein. In system 300, the scanned beam display 100 may comprise an invisible laser 310 to generate a monochrome image in addition to three visible light lasers such as green laser 312, red laser 314, and blue laser 316 to generate a full color image. The invisible wavelength laser beam 318 emitted by invisible wavelength laser 310 may be projected onto a first reflector 328 to be combined with the green laser beam 320, red laser beam 324, and blue laser beam 326 via corresponding beam combiners 330, 332, and 334 to provide a composite beam 112 that may be optionally shaped and/or combined using optics in block 222 and redirected to scanning platform 114 which generates a projected image on display screen 128 via a raster scan. In one or more embodiments, display screen may be coated and/or contain an appropriate Photoluminescent material 336 that is responsive to the invisible light beam 318 component of composite beam 112. The Photoluminescent material 336 which re-radiates the invisible light into a color in the visible spectrum. In one or more embodiments, the re-radiated light is at a color having a higher photopic response, for example yellow or near yellow light. For example, where the invisible laser comprises a UV laser, Photoluminescent material 336 may comprise a yellow emitting UV phosphor such as a coumarin phosphor, a pyrromethene phosphor, and/or a zinc selenide, among many examples. Where the invisible laser 310 is an infrared laser, Photoluminescent material 336 may comprise a yellow emitting IR phosphor. In particular embodiments, the Photoluminescent material may be selected to have a higher efficiency such that the ratio of the power of the re-radiated beam to the power of the input invisible beam is relatively high. The resulting image re-radiated from Photoluminescent material 336 may be a monochrome image in the visible light spectrum such as a yellow or near yellow monochrome image. This monochrome image may be viewed along with the full color image, for example RGB, by a viewer who is looking at display screen 128. Using known techniques, the two images comprising the monochrome image and the color image may be slightly offset at desired portions of the image in order to produce the desired three-dimensional effect. In order to view the image as a three-dimensional image, a pair of viewing glasses 338 may be utilized. Glasses 338 may include a first lens 340 having a first filter F1 and a second lens 342 having a second filter F2. The operation of glasses 338 is shown in and described with respect to FIG. 4, below.

Referring now to FIG. 4, a diagram illustrating the generation of a monochrome image and a full color image in accordance with one or more embodiments will be discussed. The viewer may utilize glasses 338 to view the projected image with a three-dimensional effect. The first filter F1 of lens 340 may be designed to pass the visible monochrome image 410 re-radiated from projection screen 128 via rays 414 to one of the viewer's eye while blocking the full color image reflected off projection screen 128 via rays 416. Likewise, the second filter F2 of lens 342 may be designed to pass the full color image 412 reflected off projection screen 128 to the viewer's other eye while blocking the monochrome image re-radiated off the projection screen 128. For example, the first filter F1 may be a band-pass filter at or near the wavelength of the monochrome image (i.e., the wavelength of the visible light that is re-radiated by the Photoluminescent material 336), and the second filter F2 may comprise a band-reject filter, or notch filter, at or near the wavelength of the monochrome image. Other types of filters likewise may be utilized, and the scope of the claimed subject matter is not limited in this respect. Furthermore, although in one or more embodiments, monochrome image 410 and full color image 412 may be generated by a single display projector and/or projector module, in one or more alternative embodiments multiple projectors and/or projector modules may be utilized wherein the multiple projectors and/or projector modules may work together to generate a three-dimensional image. For example, monochrome image 410 may be generated by a first projector and/or projector module, and full color image 412 may be generated by a second projector and/or projector module. However, this is merely one example of how multiple projectors and/or projector modules may be utilized, and the scope of the claimed subject matter is not limited in this respect.

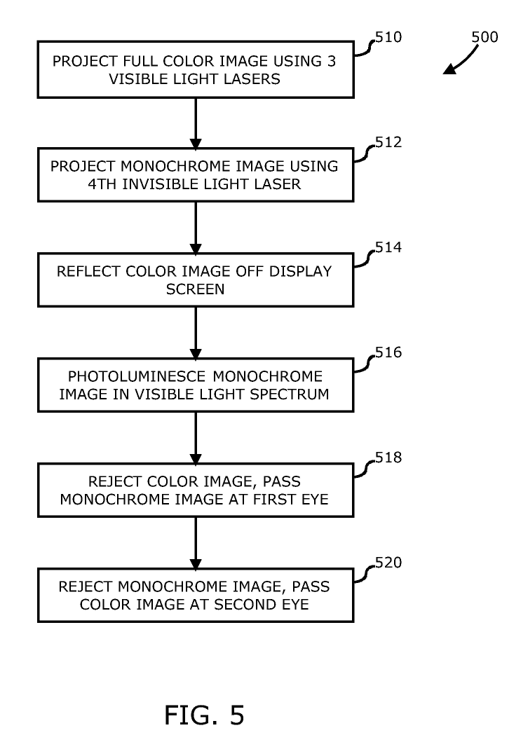

Referring now to FIG. 5, a flow diagram of a method to generate a three-dimensional image in accordance with one or more embodiments will be discussed. Method 500 shows one particular method for generating a three-dimensional image in accordance with one or more embodiments; however alternative methods may likewise be utilized without departing from the scope of the claimed subject matter. For example, the method 500 may include more or fewer blocks than shown in FIG. 5, and/or the blocks may be arranged in other orders, and the scope of the claimed subject matter is not limited in these respects. At block 510, display 100 may project a full color image using three visible light lasers or other light sources. Display 100 may also project a monochrome image using a fourth invisible light laser or other invisible light source at block 512. The full color image 412 may be reflected off display screen 128 at block 514 as visible light rays 416 toward a viewer. The invisible monochrome image may impinge on Photoluminescent material 336 of display screen 128 and may be re-radiated via photoluminescence at block 516 as a visible monochrome image in the visible light spectrum. The viewer may be wearing a pair of glasses 338 having a lens 340 for a first eye having a filter F1 that rejects the color image 412 and passes the visible monochrome image 410 to the first eye at block 518. The pair of glasses 338 also has a lens 342 for a second eye having a filter F2 that rejects the visible monochrome 410 image and passes the full color image 412 to the second eye at block 520. By driving the electronics 200 and scanning platform 114 appropriately, a three-dimensional image may be viewed by the user.

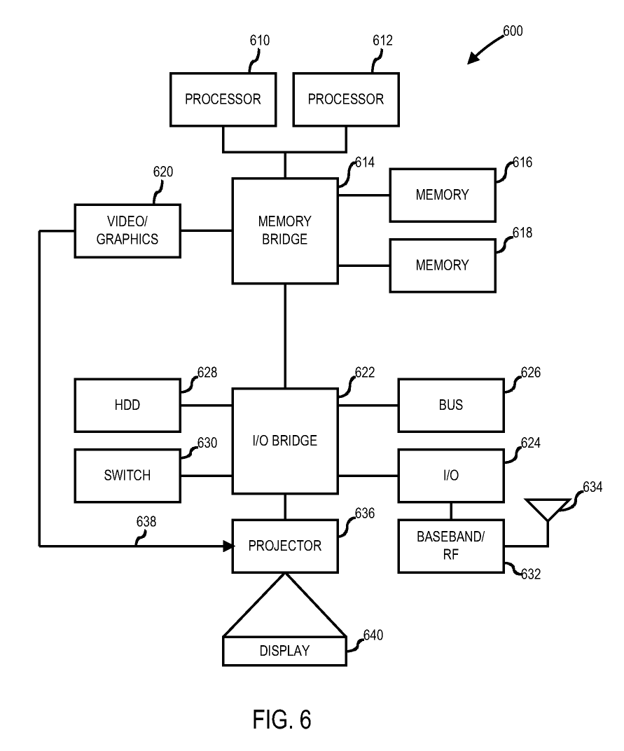

Referring now to FIG. 6, a block diagram of an information handling system utilizing a three-dimensional display projector in accordance with one or more embodiments will be discussed. Information handling system 600 of FIG. 6 may tangibly embody scanned beam display 100 as shown in and described with respect to FIG. 1. Although information handling system 600 represents one example of several types of computing platforms, including cell phones, personal digital assistants (PDAs), netbooks, notebooks, internet browsing devices, and so on, information handling system 600 may include more or fewer elements and/or different arrangements of the elements than shown in FIG. 6, and the scope of the claimed subject matter is not limited in these respects.

Information handling system 600 may comprise one or more processors such as processor 610 and/or processor 612, which may comprise one or more processing cores. One or more of processor 610 and/or processor 612 may couple to one or more memories 616 and/or 618 via memory bridge 614, which may be disposed external to processors 610 and/or 612, or alternatively at least partially disposed within one or more of processors 610 and/or 612. Memory 616 and/or memory 618 may comprise various types of semiconductor based memory, for example volatile type memory and/or non-volatile type memory. Memory bridge 614 may couple to a video/graphics system 620 to drive a display device, which may comprise projector 636, coupled to information handling system 600. Projector 636 may comprise scanned beam display 100 of FIG. 1 and/or complete system 300 of FIG. 3. In one or more embodiments, video/graphics system 620 may couple to one or more of processors 610 and/or 612 and may be disposed on the same core as the processor 610 and/or 612, although the scope of the claimed subject matter is not limited in this respect.

Information handling system 600 may further comprise input/output (I/O) bridge 622 to couple to various types of I/O systems. I/O system 624 may comprise, for example, a universal serial bus (USB) type system, an IEEE 1394 type system, or the like, to couple one or more peripheral devices to information handling system 600. Bus system 626 may comprise one or more bus systems such as a peripheral component interconnect (PCI) express type bus or the like, to connect one or more peripheral devices to information handling system 600. A hard disk drive (HDD) controller system 628 may couple one or more hard disk drives or the like to information handling system, for example Serial Advanced Technology Attachment (Serial ATA) type drives or the like, or alternatively a semiconductor based drive comprising flash memory, phase change, and/or chalcogenide type memory or the like. Switch 630 may be utilized to couple one or more switched devices to I/O bridge 622, for example Gigabit Ethernet type devices or the like. Furthermore, as shown in FIG. 6, information handling system 600 may include a baseband and radio-frequency (RF) block 632 comprising a base band processor and/or RF circuits and devices for wireless communication with other wireless communication devices and/or via wireless networks via antenna 634, although the scope of the claimed subject matter is not limited in these respects.

In one or more embodiments, information handling system 600 may include a projector 636 that may correspond to scanning platform 114 of FIG. 1 and/or system 300 of FIG. 3, and which may include any one or more or all of the components of scanned laser display 100 such as processor 122, horizontal drive circuit 118, vertical drive circuit 120, and/or laser source 110. In one or more embodiments, projector 636 may be controlled by one or more of processors 610 and/or 612 to implements some or all of the functions of controller 122 of FIG. 1. In one or more embodiments, projector 636 may comprise a MEMS based scanned laser display for displaying an image projected by projector 636 where the image may likewise be represented by target/display 640. In one or more embodiments, a scanned beam projector may comprise video/graphics block 620 having a video controller to provide video information 638 to projector 636 to display an image represented by target/display 640. In one or more embodiments, projector 636 may be capable of generating a three-dimensional image on display 640 as discussed herein. However, these are merely example implementations for projector 636 within information handling system 600, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to a three-dimensional display using an invisible wavelength light source and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
generating a full color image and projecting the full color image on a display screen via scanning platform of a scanned beam display; and
generating a monochrome image and projecting the monochrome image on the display screen via the scanning platform of the scanned beam display, the projected monochrome image comprising an invisible wavelength;
wherein the monochrome image is re-radiated from a Photoluminescent material of the display screen as a monochrome image comprising a visible wavelength; and
wherein the image may be viewed by a viewer as a three-dimensional image if the monochrome image is provided to a first eye of the user without the full color image, and the full color image is provided to a second eye of the user without the monochrome image.

2. A method as claimed in claim 1, wherein said generating a monochrome image comprises generating a monochrome image comprising an ultraviolet wavelength.

3. A method as claimed in claim 1, wherein said generating a monochrome image comprises generating a monochrome image comprising an infrared wavelength.

4. A method as claimed in claim 1, wherein the monochrome image is re-radiated from the Photoluminescent material at a yellow or near-yellow wavelength.

5. A method as claimed in claim 1, wherein the monochrome image is provided to a first eye of the user without the full color image by passing the monochrome image and filtering the full color image.

6. A method as claimed in claim 1, wherein the full color image is provided to a second eye of the user without the monochrome image by passing the full color image and filtering the monochrome image.

7. A three-dimensional display, comprising:
a first set of one or more light sources to generate a three color light output;
a second set of one or more light sources to generate a monochrome light output, the monochrome light output being at or near an invisible wavelength; and
a scanning platform to generate a full color image on a display screen from the three color light output and to generate a monochrome image on the display screen from the monochrome light output;
wherein the monochrome image is re-radiated from a Photoluminescent material of the display screen as a monochrome image comprising a visible wavelength; and
wherein the image may be viewed by a viewer as a three-dimensional image if the monochrome image is provided to a first eye of the user without the full color image, and the full color image is provided to a second eye of the user without the monochrome image.

8. A three-dimensional display as claimed in claim 7, wherein the monochrome light output comprises light having an ultraviolet wavelength, or wherein the monochrome light output comprises light having an infrared wavelength, or combinations thereof.

9. A three-dimensional display as claimed in claim 7, wherein the monochrome image is re-radiated from the Photoluminescent material at a yellow or near-yellow wavelength.

10. A three-dimensional display as claimed in claim 7, wherein the monochrome image is provided to a first eye of the user without the full color image by passing the monochrome image and filtering the full color image.

11. A three-dimensional display as claimed in claim 7, wherein the full color image is provided to a second eye of the user without the monochrome image by passing the full color image and filtering the monochrome image.

12. A three-dimensional display as claimed in claim 7, wherein the first set of light sources comprises three color lasers, a three color digital light projector, or a three color liquid crystal on silicon device, or combinations thereof, and the second set of light sources comprises an invisible wavelength laser, an invisible wavelength digital light projector, or an invisible wavelength liquid crystal on silicon device, or combinations thereof.

13. A three-dimensional display as claimed in claim 14, wherein the first set of one or more light sources is disposed in a first projector and wherein the second set of one or more light sources is disposed in a second projector.

14. An information handling system, comprising:
a processor and a memory coupled to the processor; and
a three-dimensional display coupled to the processor, the three-dimensional display comprising:
a first set of one or more light sources to generate a three color light output;
a second set of one or more light sources to generate a monochrome light output, the monochrome light output being at or near an invisible wavelength; and
a scanning platform to generate a full color image on a display screen from the three color light output and to generate a monochrome image on the display screen from the monochrome light output;
wherein the monochrome image is re-radiated from a Photoluminescent material of the display screen as a monochrome image comprising a visible wavelength; and
wherein the image may be viewed by a viewer as a three-dimensional image if the monochrome image is provided to a first eye of the user without the full color image, and the full color image is provided to a second eye of the user without the monochrome image.

15. An information handling system as claimed in claim 14, wherein the monochrome light output comprises light having an ultraviolet wavelength, or wherein the monochrome light output comprises light having an infrared wavelength, or combinations thereof.

16. An information handling system as claimed in claim 14, wherein the monochrome image is re-radiated from the Photoluminescent material at a yellow or near-yellow wavelength.

17. An information handling system as claimed in claim 14, wherein the monochrome image is provided to a first eye of the user without the full color image by passing the monochrome image and filtering the full color image.

18. An information handling system as claimed in claim 14, wherein the full color image is provided to a second eye of the user without the monochrome image by passing the full color image and filtering the monochrome image.

19. An information handling system as claimed in claim 14, wherein the first set of light sources comprises three color lasers, a three color digital light projector, or a three color liquid crystal on silicon device, or combinations thereof, and the second set of light sources comprises an invisible wavelength laser, an invisible wavelength digital light projector, or an invisible wavelength liquid crystal on silicon device, or combinations thereof.

20. An information handling system as claimed in claim 14, wherein the first set of one or more light sources is disposed in a first projector and wherein the second set of one or more light sources is disposed in a second projector.
